(19) United States
(12) Patent Application Publication
(10) Pub. No.: US 2026/0119408 A1
(43) Pub. Date: Apr. 30, 2026

(54) APPARATUS AND METHOD FOR MANAGING MEMORY PAGES, AND NON- TRANSITORY COMPUTER-READABLE MEDIUM

(71) Applicant: Intel Corporation, Santa Clara, CA (US)

(72) Inventors: Stijn EYERMAN, Evergem (BE); Wim HEIRMAN, Aalter VOV (BE); Vinodh GOPAL, Westborough, MA (US); Wajdi FEGHALI, Boston, MA (US)

(21) Appl. No.: 19/428,534

(22) Filed: Dec. 22, 2025

(51) Int. Cl. G06F 12/1009

(52) U.S. Cl. CPC G06F 12/1009

(57) ABSTRACT

It is provided an apparatus comprising interface circuitry, machine-readable instructions, and processing circuitry to execute the machine-readable instructions. The machine-readable instructions include instructions to maintain at least three page classes for a system memory. The at least three page classes comprise an uncompressed page class, a first compressed page class, and a second compressed page class. The machine-readable instructions further include instructions to determine a target page class from the at least three page classes for a page based on the determined status indicator corresponding to a memory page. The status indicator comprises at least a write-recency indicator and a read-recency indicator. The machine-readable instructions further include instructions to, in response to a determination that the target page is not matching a current page class of the page, migrate the page to the target page class.

### BACKGROUND

Memory compression may increase the effective capacity of system memory without requiring additional physical memory hardware. In memory compression systems, data stored in memory may be compressed to reduce physical space requirements, and may be decompressed when accessed by processing circuitry. However, decompression operations may introduce performance overhead, particularly when decompression requires operating system intervention through page fault handling mechanisms. Some memory compression approaches may compress only infrequently accessed data to limit performance impact, as the overhead of page faults for each access to compressed data may make it impractical to compress frequently accessed pages. Some systems may increasingly require both high memory capacity and performance, determining which memory pages to compress and which compression schemes to apply may present challenges.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus for managing memory pages;

FIG. 2 illustrates a flowchart of an example of a method for managing memory pages;

FIG. 3 illustrates a block diagram of an example of a non-transitory computer-readable medium;

FIG. 4 illustrates an example of a system for managing memory pages; and

FIG. 5 illustrates a block diagram of an example computer system or computing device.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

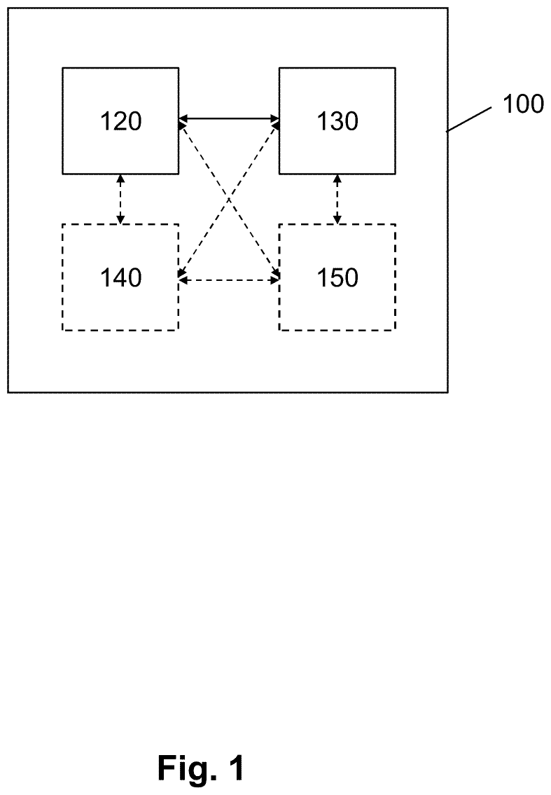

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) memory circuitry 140. For example, the processing circuitry 130 may be coupled with the interface circuitry 120 and optionally with the memory circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the memory circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the memory circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the memory circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the memory circuitry 140 or means for storing information 140 may comprise at least one element of the group of volatile memory technologies, such as Dynamic Random Access Memory (DRAM), Static Random Access Memory (SRAM), Synchronous DRAM (SDRAM), Double Data Rate SDRAM (DDR SDRAM), or other random access memory technologies that provide the system memory for active data and program code during system operation. In some examples, the memory circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to maintain at least three page classes for a system memory. In some examples, a system memory may refer to the main memory of a computing system where data and instructions are stored for access by processing circuitry 130. The system memory may serve as the primary storage location for active data and program code during system operation. The system memory may provide random access to stored data, allowing the processing circuitry to read from and write to various memory locations. For example, the system memory may be implemented as the memory circuitry 140, which may comprise dynamic random access memory (DRAM) modules, or other volatile or non-volatile memory technologies.

In some examples, a memory page may refer to a fixed-size block of memory that serves as the basic unit of memory management. The memory page may represent a contiguous region of physical or virtual memory that the operating system manages as a single entity. Memory pages may be the granularity at which memory allocation, protection, and swapping operations are performed. For example, a memory page may have a size of 4 kilobytes, though other page sizes such as 2 megabytes or 1 gigabyte may be used depending on the system architecture.

In some examples, a page class may refer to a category or grouping of memory pages that share common characteristics, such as being managed according to a common policy. The page class may define how memory pages within that class are stored, accessed, and/or processed. Different page classes may be subject to different management policies, compression schemes, and/or storage locations. For example, pages may be assigned to different classes based on their access patterns, compression status, or expected future usage.

In some examples, compressing a memory page may refer to the process of reducing the size of the data stored in that page by applying a compression algorithm. The compression process may encode the original data in a more compact form that requires less physical storage space. Compressing memory pages may increase the effective capacity of the system memory by allowing more data to be stored in the same physical memory space. Compression may also reduce memory bandwidth requirements when compressed data is transferred through the memory channel. The compression may be performed by dedicated compression hardware, by the processing circuitry executing compression software, or by a combination of hardware and software. Different compression schemes may be used depending on the desired balance between compression ratio, compression speed, and decompression speed. For example, a memory page containing repetitive data patterns may be compressed to a fraction of its original size, allowing multiple compressed pages to occupy the physical memory space that would otherwise hold a single uncompressed page.

The at least three page classes comprise an uncompressed page class, a first compressed page class associated with a first page compression scheme, and a second compressed page class associated with a second page compression scheme. In some examples, the uncompressed page class may refer to a category of memory pages that are stored in their original, uncompressed form. Memory pages in the uncompressed page class may be directly accessible by the processing circuitry without requiring any decompression operation. The uncompressed page class may be used for pages that are frequently written to, since writes to compressed pages may incur significant overhead. Pages in the uncompressed page class may offer the lowest access latency but may consume more physical memory space compared to compressed pages. For example, newly allocated pages and pages that have been recently written may belong to the uncompressed page class to avoid the performance penalty associated with decompressing and recompressing data on each write operation.

In some examples, the first compressed page class may refer to a category of memory pages that are stored in compressed form using the first page compression scheme. The first page compression scheme may be optimized for fast decompression to minimize the performance impact when accessing these pages. Memory pages in the first compressed page class may be frequently read but infrequently written. The first compressed page class may provide a balance between memory capacity savings and access performance. The first compressed page class may contain hot data, which may refer to data that is accessed frequently for read operations. For example, the first compressed page class may contain pages that are accessed regularly for read operations, where the decompression latency of the first page compression scheme is low enough to avoid significant performance degradation.

In some examples, the second compressed page class may refer to a category of memory pages that are stored in compressed form using the second page compression scheme. The second page compression scheme may achieve a higher compression ratio than the first page compression scheme, but may have a longer decompression latency. Memory pages in the second compressed page class may be accessed infrequently, making them less sensitive to decompression overhead. The second compressed page class may maximize memory capacity savings for cold data that is rarely accessed. Cold data may refer to data that has not been accessed recently and is unlikely to be accessed in the near future. For example, the second compressed page class may contain pages that have not been accessed for an extended period, where the higher compression ratio of the second page compression scheme provides substantial memory savings and the longer decompression latency is acceptable due to the infrequent access pattern.

In some examples, the first page compression scheme may have a lower decompression latency than the second page compression scheme. The lower decompression latency of the first page compression scheme may make it suitable for pages that are accessed more frequently, where minimizing access time is important for maintaining system performance. The second page compression scheme may prioritize compression ratio over decompression speed, making it appropriate for infrequently accessed pages where the longer decompression time has minimal impact on overall performance. The difference in decompression latency may be achieved through different compression algorithms, different compression parameters, or different chunk sizes. For example, the first page compression scheme may achieve a 2× to 3× compression ratio with a decompression latency of less than 200 nanoseconds, while the second page compression scheme may achieve a 4× to 6× compression ratio with a decompression latency greater than 500 nanoseconds.

In some examples, the at least three page classes may be implemented as respective lists. Each list may contain references to or entries for the memory pages belonging to that particular page class. The lists may be organized as first-in-first-out (FIFO) structures, linked lists, or other data structures that maintain an ordering of the pages. The lists may facilitate the identification of candidate pages for migration between classes based on their position within the list. For example, pages at the head of a list may represent the oldest pages in that class and may be evaluated first for potential migration to another page class. The lists may implement a least-recently-used (LRU) or pseudo-LRU eviction policy where pages that have not been accessed recently move toward the head of the list.

In some examples, a compressed page table (CPT) may be used by the processing circuitry 130. The CPT may be a data structure that maintains metadata about compressed memory pages. The CPT may store information necessary to locate, decompress, and manage compressed pages in the system memory. The CPT may enable the hardware and operating system to track which pages are compressed and how to access their compressed data. Each entry in the CPT may correspond to a compressed memory page and may contain information such as the physical location of the compressed data, the compression scheme used, the size of the compressed data, and other metadata required for decompression. The CPT may be consulted during memory access operations to determine whether a requested page is compressed and to retrieve the information needed to decompress it. For example, when the processing circuitry attempts to read from a memory address that belongs to a compressed page, the memory controller may look up the corresponding entry in the CPT to determine the compression scheme and the location of the compressed data.

In some examples, the CPT may comprise entries for memory pages belonging to both the first compressed page class and the second compressed page class. The CPT may maintain a unified index of all compressed pages regardless of which compressed page class they belong to. Each entry in the CPT may include an indication of which compression scheme was used, thereby distinguishing between pages in the first compressed page class and pages in the second compressed page class. This unified approach may simplify the hardware implementation by providing a single lookup structure for all compressed pages. For example, a single CPT may contain entries for pages compressed with the first page compression scheme and entries for pages compressed with the second page compression scheme, with each entry including a field that specifies which compression scheme applies to that particular page.

The processing circuitry 130 is further configured to determine a target page class from the at least three page classes for a page based on the determined status indicator corresponding to a memory page. The determination may involve evaluating characteristics of the memory page to identify which page class would be most appropriate for that page. The target page class may represent the page class to which the memory page should belong based on its current characteristics and access patterns. The determination process may be performed periodically, in response to specific events, or as part of ongoing memory management operations. For example, the processing circuitry may determine a target page class for a memory page that is currently residing in one of the page classes, or for a newly allocated memory page that needs to be assigned to an initial page class.

In some examples, the memory page for which the target page class is determined may originate from various sources within the memory management system. The memory page may be a newly allocated page that has not yet been assigned to any page class. The memory page may be an existing page that currently belongs to one of the at least three page classes and is being evaluated for potential migration to a different page class. The memory page may be a page that has reached a specific position within a list corresponding to its current page class, triggering an evaluation of whether it should remain in that class or move to another. The memory page may be a page involved in a page fault or other memory access event that prompts a reevaluation of its appropriate page class. For example, the memory page may be at the head of the list implementing the uncompressed page class, indicating it is the oldest page in that class and should be evaluated to determine whether it should migrate to one of the compressed page classes.

In some examples, the target page class may refer to the page class that the processing circuitry 130 determines to be most suitable for the memory page based on its characteristics. The target page class may be the same as the current page class of the memory page, indicating that the page should remain where it is. The target page class may be different from the current page class, indicating that the page should be migrated to a different page class. The determination of the target page class may aim to optimize memory utilization and system performance by ensuring that each page resides in the most appropriate class based on its access pattern. For example, if a memory page in the uncompressed page class has not been written recently but is being read frequently, the target page class may be determined to be the first compressed page class, allowing the page to be compressed with a fast-decompression scheme.

In some examples, determining the target page class may be based on a status indicator corresponding to the memory page. The status indicator may comprise information about the access history or characteristics of the memory page. In some examples, the status indicator may be maintained by the processing circuitry 130 or by the operating system. The processing circuitry 130 may set or update certain components of the status indicator automatically during memory access operations. For example, the processing circuitry 130 may automatically set bits of the status indicator when a memory page is accessed, while the machine-readable instructions may periodically read and reset these bits to track access patterns over time. The status indicator may be updated as the memory page is accessed, reflecting recent activity related to that page. The status indicator may provide the basis for deciding which page class is most appropriate for the memory page at any given time. For example, the status indicator may include bits or flags that are set or cleared by hardware when the memory page is accessed, allowing the operating system to determine the page's access pattern when evaluating its target page class.

In some examples, the status indicator may comprise at least a write-recency indicator and a read-recency indicator. The write-recency indicator may provide information about whether the memory page has been written to recently. The read-recency indicator may provide information about whether the memory page has been read from recently. These two indicators may allow the processing circuitry to distinguish between different access patterns that warrant different compression treatments. The write-recency indicator may identify pages that are frequently written and should remain uncompressed to avoid migration overhead. The read-recency indicator may identify pages that are frequently read and may be suitable for compression with a fast-decompression scheme, or pages that are rarely read and may be suitable for compression with a high-compression scheme. For example, a page with the write-recency indicator showing recent writes may have its target page class determined to be the uncompressed page class, while a page with the write-recency indicator showing no recent writes but the read-recency indicator showing recent reads may have its target page class determined to be the first compressed page class.

Coming back to the performing of the determining process. In some examples, the processing circuitry 130 may be further configured to initiate the determining of the target page class for the memory page in response to specific triggering events. The initiation may occur at particular moments during memory management operations when evaluation of the page's appropriate class becomes necessary or beneficial. The triggering events may be selected to balance the frequency of evaluations against the overhead of performing them. The initiation in response to these events may ensure that pages are evaluated at appropriate times without excessive computational burden. For example, the processing circuitry 130 may initiate the determination periodically during system operation, or may initiate it reactively in response to specific memory-related events.

In some examples, the determining of the target page class may be initiated in response to an insertion of the memory page into system memory. The insertion may occur when a new page is allocated for use by an application or the operating system. The insertion may occur when a page is brought into system memory from persistent storage or from a secondary memory tier. At the time of insertion, the processing circuitry may evaluate the characteristics of the newly inserted page to determine which page class it should initially belong to. This initial determination may be based on the type of page, its expected usage pattern, or other available information. For example, a newly allocated writable page may have its target page class initially determined to be the uncompressed page class because it is likely to be written during initialization, while a read-only file page loaded from storage may have its target page class initially determined to be one of the compressed page classes.

In some examples, the determining of the target page class may be initiated in response to the memory page reaching a predetermined position within the respective list corresponding to its current page class. The predetermined position may be the head of the list or another specified position within the list that triggers evaluation. The page scan phase may be a periodic or triggered operation during which the machine-readable instructions cause the processing circuitry to examine pages to evaluate their status and make management decisions. The respective lists may operate according to a first-in-first-out (FIFO) principle, where pages are added to a tail of the list and progress toward the head over time. A memory page newly inserted into system memory or newly migrated to one of the respective lists may be added to the tail of that list. The lists implementing the page classes may be organized such that pages move toward the head as they age within that class. When a page reaches the head of its list, it may represent the oldest or least recently accessed page in that class, making it a candidate for migration to another class. The processing circuitry may initiate the determination upon the page reaching the predetermined position to decide whether it should remain in its current class or migrate. For example, when a page in the uncompressed page class reaches the head of the uncompressed list during a page scan, the processing circuitry may examine its write-recency indicator to determine whether it should migrate to the first compressed page class.

In some examples, the determining of the target page class may be initiated in response to a page fault associated with the memory page. The page fault may occur when the processing circuitry attempts to access the memory page in a manner that is not permitted by its current state or location. The page fault may occur when a write access targets a page that is currently in a compressed page class, since writes to compressed pages may not be directly supported. The page fault may trigger the operating system to reevaluate which page class is appropriate for the page given the access that caused the fault. The processing circuitry may determine that the target page class should be the uncompressed page class to accommodate the write access. For example, if a page in the first compressed page class receives a write access, a page fault may be generated, prompting the processing circuitry to determine that the target page class is the uncompressed page class and to migrate the page accordingly.

In some examples, the determining of the target page class may also be initiated in response to a list corresponding to a page class approaching or reaching its full size. Each page class may have an associated capacity limit, and when the number of pages in a class approaches this limit, the processing circuitry may need to migrate some pages to other classes to make room. The processing circuitry may evaluate pages in the nearly-full list to identify candidates for migration. This evaluation may involve determining target page classes for pages at or near the head of the list. For example, when the uncompressed page class list approaches its capacity limit, the processing circuitry may examine pages at the head of the uncompressed list to determine whether their target page class is one of the compressed page classes, allowing those pages to be migrated and freeing space in the uncompressed class.

In some examples, the write-recency indicator may be distinct from a writeback indicator (such as a “pg_dirty” bit) used to track a writeback requirement for the memory page. The write-recency indicator may track whether the memory page has been written to recently, for purposes of determining the appropriate page class for the memory page. The writeback indicator may track whether the memory page contains modified data that needs to be written back to persistent storage or to a backing store. The writeback indicator may need to remain set until the modified data has been successfully written back, which may occur long after the most recent write to the page. The write-recency indicator may be reset more frequently to track only recent write activity relevant to compression decisions. This separation may allow the system to distinguish between pages that were written recently and should remain uncompressed, versus pages that were written at some point in the past but have not been written recently and may be candidates for compression. For example, the processing circuitry may set both the write-recency indicator and the writeback indicator when a write occurs to a memory-mapped file page, but the machine-readable instructions may later reset the write-recency indicator while keeping the writeback indicator set until the page's contents are flushed to the file system.

The processing circuitry 130 is further configured to, in response to a determination that the target page is not matching a current page class of the page, migrate the page to the target page class. The migration may occur when the evaluation of the status indicator reveals that a different page class would be more appropriate for the memory page than the page class in which it currently resides. The migration may be conditional upon the target page class differing from the current page class, avoiding unnecessary operations when the page is already in the appropriate class. The determination and migration may form a coordinated process where the evaluation of page characteristics leads directly to corrective action when needed. For example, if the processing circuitry 130 determines that the target page class for a memory page currently in the uncompressed page class is the first compressed page class, the processing circuitry 130 may initiate migration of that page to the first compressed page class.

In some examples, the migration being performed in response to the determination may mean that the migration operation is triggered by and follows from the determination that the target page class does not match the current page class. The response may be immediate or may be deferred depending on system conditions and resource availability. The response may involve initiating a series of operations necessary to effect the migration.

The migration may be performed as part of the same processing flow that made the determination, or may be queued for later execution. For example, during a page scan phase, when the processing circuitry determines that a page at the head of the uncompressed list should migrate to the first compressed page class, the processing circuitry 130 may immediately begin the migration process, or may add the page to a queue of pages pending migration.

In some examples, migrating the memory page to the target page class may refer to the process of changing the page class membership of the memory page from its current page class to the target page class. The migration may involve multiple sub-operations including removing the page from data structures associated with the current page class, adding the page to data structures associated with the target page class, and modifying the storage format or location of the page's data as appropriate for the target page class. The migration may update metadata associated with the page to reflect its new class membership. The migration may be atomic from the perspective of memory accesses, ensuring that the page remains accessible throughout the transition. For example, migrating a page from the uncompressed page class to the first compressed page class may involve removing the page's entry from the uncompressed list, compressing the page's data, storing the compressed data in the compressed partition of the memory circuitry, creating an entry in the CPT for the compressed page, and adding a reference to the page to the first compressed page class list.

In some examples, the migration may be performed through various mechanisms depending on the current and target page classes involved. Migration from the uncompressed page class to a compressed page class may involve compressing the page data. Migration between different compressed page classes may involve recompressing the page data using a different compression scheme. Migration from a compressed page class to the uncompressed page class may involve decompressing the page data. The migration may also involve updating page tables to reflect the new location or status of the page. The migration may involve moving data between different physical regions of the memory circuitry, such as between an uncompressed partition and a compressed partition. For example, when migrating a page from the first compressed page class to the second compressed page class, the processing circuitry may fetch the currently compressed data, decompress it, recompress it using the second page compression scheme, store the newly compressed data in the memory circuitry, and update the corresponding CPT entry to reflect the new compression scheme and data location.

In some examples, the apparatus 100 may further comprise a decompression controller 150. In some examples, the decompression controller may refer to a hardware component configured to perform decompression operations on compressed memory pages. The decompression controller may be implemented as dedicated hardware logic, an accelerator unit, or specialized circuitry within the memory subsystem. The decompression controller may intercept read accesses to compressed memory pages and automatically decompress the requested data before providing it to the requesting processing circuitry. The decompression controller may operate independently of the operating system's page fault handling mechanisms. For example, the decompression controller may be integrated into the memory controller or may be a separate hardware unit positioned between the processing circuitry and the memory circuitry.

In some examples, the decompression controller may be configured to perform decompression transparently to the operating system without generating an operating system page fault when the memory page receives a read access in a compressed page class. The decompression controller may handle read accesses to compressed pages entirely in hardware without involving the operating system. This transparent decompression may avoid the significant overhead associated with page fault handling, context switching, and operating system intervention. The decompression controller may detect that a memory access targets a compressed page, retrieve the compressed data, decompress it, and provide the decompressed data to the requesting core without triggering a page fault. For example, when the processing circuitry issues a read request to an address belonging to a compressed page, the decompression controller may consult the CPT to determine the compression scheme and location of the compressed data, fetch and decompress the data, and return the requested cache line to the processing circuitry, all without the operating system being aware that decompression occurred.

In some examples, a read access to the memory page being in a compressed page class may be serviced by the decompression controller transparently to the operating system, without generating an operating system page fault. The transparent servicing of read accesses may enable compressed pages to be accessed with minimal performance penalty compared to uncompressed pages. The avoidance of page faults may eliminate the substantial latency and overhead associated with trapping to the operating system, saving and restoring processor state, and executing page fault handlers. This transparent decompression capability may make it practical to compress frequently accessed read-only data, which would be impractical if each access required a page fault. For example, pages containing frequently read program code or read-only data structures may be kept in the first compressed page class, where the combination of the first page compression scheme's low decompression latency and the decompression controller's transparent hardware decompression allows these pages to be accessed efficiently without operating system intervention.

In some examples, the disclosed apparatus 100 may enable significant increases in effective memory capacity without requiring additional physical memory. The three-class page management policy may allow the apparatus 100 to compress a substantially larger portion of the system memory compared to conventional approaches that only compress cold data. The distinction between the first compressed page class and the second compressed page class may optimize the balance between compression ratio and access performance for different types of data. The apparatus 100 may maximize memory capacity savings while minimizing performance overhead by intelligently matching compression schemes to access patterns based on the write-recency indicator and the read-recency indicator.

In some examples, the apparatus 100 may be combined with transparent hardware decompression capabilities. The transparent decompression by the decompression controller may enable the apparatus 100 to place frequently read pages in compressed page classes without incurring prohibitive page fault overhead. For example, without transparent hardware decompression, all read accesses to compressed pages may generate page faults, making it impractical to compress any but the most infrequently accessed pages. The transparent decompression capability may increase the potential of the three-class compression policy by making it feasible to compress a much larger portion of the system memory while maintaining acceptable performance. For example, the apparatus 100 may compress 60-80% of memory by including both hot read data in the first compressed page class and cold data in the second compressed page class, compared to conventional systems that may only compress 10-20% of memory.

### Page Class Determination and Migration

In some examples, determining the target page class may comprise determining the uncompressed page class as the target page class in response to the write-recency indicator indicating a recent write. The write-recency indicator indicating a recent write may signal that the memory page is being actively modified and should remain in an uncompressed state to avoid migration overhead. Pages that are frequently written may incur significant performance penalties if kept in a compressed page class, since each write would require decompression, modification, and recompression or migration. The determination of the uncompressed page class as the target may ensure that such actively written pages remain directly accessible without compression-related overhead. For example, when the processing circuitry evaluates a memory page during a page scan phase and finds that the write-recency indicator is set, indicating that the page has been written recently, the processing circuitry may determine that the target page class is the uncompressed page class, ensuring the page remains uncompressed even if it is currently in the uncompressed page class or prompting migration back to the uncompressed page class if it is currently in a compressed page class.

In some examples, the determination of the uncompressed page class as the target may also occur when the uncompressed page class list is approaching its full size. When memory pressure increases and the uncompressed partition approaches capacity, the processing circuitry may still determine that pages with recent writes should remain in or migrate to the uncompressed page class despite space constraints. This may trigger migration of other pages without recent writes from the uncompressed page class to make room. For example, even when the uncompressed list is nearly full, a page in a compressed page class that receives a write access and has its write-recency indicator set may have its target page class determined to be the uncompressed page class, necessitating the migration of a page without recent writes from the uncompressed class to a compressed class to accommodate it.

In some examples, when the uncompressed list is full or approaching capacity, pages at the head of the list may be examined during page scans. Pages at the head with the write-recency indicator set may be moved back to the tail of the uncompressed list with the write-recency indicator reset. Pages at the head without the write-recency indicator set may be migrated to the first compressed page class to free space.

In some examples, determining the target page class may comprise determining the first compressed page class as the target page class in response to the write-recency indicator indicating an absence of recent writes for a page currently in the uncompressed page class. The absence of recent writes may indicate that the page is no longer being actively modified and may be a candidate for compression. Pages that are read frequently but not written may benefit from compression using the first page compression scheme, which may provide memory capacity savings while maintaining low decompression latency for read accesses. The determination may occur when the page reaches the head of the uncompressed list during a page scan phase, indicating it has aged sufficiently without write activity. For example, when a page at the head of the uncompressed list is examined and the write-recency indicator is not set, the processing circuitry may determine that the target page class is the first compressed page class, identifying the page as a candidate for compression with the first page compression scheme.

In some examples, the determination of the first compressed page class as the target may also be influenced by the uncompressed page class list approaching its full size. When the uncompressed partition approaches capacity, pages without recent writes may be prioritized for migration to the first compressed page class to free space for pages that require uncompressed storage. The processing circuitry may accelerate the evaluation of pages in the uncompressed list when memory pressure increases. For example, when the uncompressed list approaches its capacity limit and new pages need to be allocated in the uncompressed page class, the processing circuitry may examine pages at the head of the uncompressed list to identify those without recent writes and determine their target page class to be the first compressed page class, enabling their migration to make room for the newly allocated pages.

In some examples, migrating the memory page from the uncompressed page class to the first compressed page class may comprise compressing the memory page using the first page compression scheme. The compression process may reduce the size of the page data, allowing it to occupy less physical space in the memory circuitry. The first page compression scheme may be applied to achieve a moderate compression ratio while maintaining low decompression latency suitable for frequently accessed data. The migration may involve reading the uncompressed page data, applying the first page compression scheme to generate compressed data, storing the compressed data in the compressed partition of the memory circuitry, creating or updating an entry in the CPT with information about the compressed page, and updating the list structures to move the page from the uncompressed list to the first compressed list. For example, when a page is migrated from the uncompressed page class to the first compressed page class, the processing circuitry may compress the page data using a compression algorithm configured for fast decompression, store the resulting compressed data at a location in the compressed memory partition, record the compression scheme and location in the CPT, and add the page to the tail of the first compressed list.

In some examples, determining the target page class may comprise determining the second compressed page class as the target page class in response to the read-recency indicator indicating an absence of recent reads for a page currently in the first compressed page class. The absence of recent reads may indicate that the page has become cold and is no longer being frequently accessed. Cold pages may benefit from higher compression ratios even at the expense of longer decompression latency, since they are accessed infrequently. The determination may occur when the page reaches the head of the first compressed list during a page scan phase, indicating it has not been accessed recently. For example, when a page at the head of the first compressed list is examined and the read-recency indicator is not set, the processing circuitry may determine that the target page class is the second compressed page class, identifying the page as a candidate for recompression with the second page compression scheme that achieves higher compression ratios.

In some examples, the determination of the second compressed page class as the target may also be influenced by the first compressed page class list approaching its full size. When the first compressed partition approaches capacity, pages without recent reads may be migrated to the second compressed page class to free space for newly compressed hot pages. The higher compression ratio of the second page compression scheme may allow more pages to fit in the available compressed memory space. For example, when the first compressed list approaches its capacity and new pages need to be compressed using the first page compression scheme, pages at the head of the first compressed list without recent reads may have their target page class determined to be the second compressed page class, enabling migration to make room.

In some examples, migrating the memory page from the first compressed page class to the second compressed page class may comprise recompressing the memory page using the second page compression scheme. The recompression process may involve decompressing the page data from its current compression format, then compressing it again using the second page compression scheme that achieves a higher compression ratio. The migration may result in the page occupying even less physical space in the memory circuitry, at the cost of increased decompression latency if the page is subsequently accessed. The migration may involve fetching the currently compressed data, decompressing it, applying the second page compression scheme to generate newly compressed data with a higher compression ratio, storing the newly compressed data in the compressed partition, updating the corresponding entry in the CPT to reflect the new compression scheme and location, and updating the list structures to move the page from the first compressed list to the second compressed list. For example, when a cold page is migrated from the first compressed page class to the second compressed page class, the processing circuitry may decompress its data from the first compression format, recompress it using a compression algorithm optimized for maximum compression ratio, store the more compact compressed data, and update the CPT entry to indicate the second page compression scheme is now in use for that page.

In some examples, the processing circuitry 130 may be further configured to, in response to the read-recency indicator indicating an absence of recent reads for a page currently in the second compressed page class, swap the memory page to a persistent storage medium. The persistent storage medium may be included in the apparatus 100 or may be connected to the system memory 150 and/or the apparatus 100. The persistent storage medium may comprise non-volatile storage such as a solid-state drive (SSD), a hard disk drive, or other secondary storage. Pages in the second compressed page class that have not been read recently may represent the coldest data in the system, making them candidates for removal from the system memory entirely. Swapping such pages to the persistent storage medium may free additional space in the system memory for more actively used data. The swapping operation may involve writing the compressed page data to the persistent storage medium and removing the page from the second compressed page class list and from the system memory. For example, when a page at the head of the second compressed list is examined during a page scan phase and the read-recency indicator indicates no recent reads, and particularly when the second compressed page class list is approaching its full size, the processing circuitry may swap the page to the persistent storage medium, effectively extending the memory hierarchy to include persistent storage for the coldest data.

In some examples, the processing circuitry 130 may be further configured to, in response to a write access targeting the memory page while it is in a compressed page class, migrate the memory page directly to the uncompressed page class. A write access to a compressed page may not be directly supported since compressed data cannot be modified in place without decompression. The write access targeting a compressed page may generate a page fault that triggers the migration. The page fault may be handled by the machine-readable instructions, which may initiate the migration to the uncompressed page class to allow the write operation to proceed. The direct migration to the uncompressed page class may bypass the intermediate compressed page classes, recognizing that a page receiving a write should be stored uncompressed regardless of its prior compression state. The write-recency indicator for the page may be set as a result of the write access. For example, when the processing circuitry attempts to write to a page in the first compressed page class or the second compressed page class, a page fault may be generated, prompting the machine-readable instructions to migrate the page directly to the uncompressed page class, decompress it if necessary, and then allow the write operation to complete.

In some examples, migrating the memory page to the uncompressed page class may comprise decompressing the memory page. The decompression process may restore the page data to its original uncompressed form, making it directly accessible for both read and write operations. Decompression may be necessary when a page is migrated from either the first compressed page class or the second compressed page class to the uncompressed page class. The decompression may be performed by the processing circuitry executing the machine-readable instructions using the appropriate decompression algorithm corresponding to the compression scheme that was used to compress the page. The decompressed data may be stored in the uncompressed partition of the memory circuitry, and the page's entry may be removed from the CPT. For example, when a page in the first compressed page class receives a write access and must be migrated to the uncompressed page class, the machine-readable instructions may cause the processing circuitry to fetch the compressed data, decompress it using the decompression algorithm corresponding to the first page compression scheme, store the decompressed data in the uncompressed memory partition, and add the page to the uncompressed page class list.

In some examples, migrating the memory page to the target page class may comprise compressing or recompressing the memory page. Compressing may occur when migrating from the uncompressed page class to a compressed page class, involving the application of a compression scheme to previously uncompressed data. Recompressing may occur when migrating between different compressed page classes, involving decompression followed by compression with a different compression scheme. The choice between compressing and recompressing may depend on the current page class and the target page class of the memory page. Migration operations that move pages toward higher compression states may involve these compression or recompression operations to achieve the memory capacity savings associated with the target page class. For example, migrating a page from the uncompressed page class to the first compressed page class may comprise compressing the page using the first page compression scheme, while migrating a page from the first compressed page class to the second compressed page class may comprise recompressing the page by first decompressing it and then compressing it using the second page compression scheme.

In some examples, migrating the memory page to the target page class may comprise updating the CPT. The updating of the CPT may be necessary when a page transitions between compressed and uncompressed states or between different compressed page classes. The update may involve creating a new entry in the CPT, modifying an existing entry, or removing an entry from the CPT depending on the nature of the migration. When a page is migrated from the uncompressed page class to a compressed page class, a new entry may be created in the CPT to record the compression scheme, the location of the compressed data, and other metadata required for accessing the compressed page. When a page is migrated between compressed page classes, the existing CPT entry may be updated to reflect the new compression scheme and the new location of the recompressed data. When a page is migrated from a compressed page class to the uncompressed page class, the corresponding entry may be removed from the CPT since uncompressed pages do not require CPT entries. For example, when migrating a page from the first compressed page class to the second compressed page class, the processing circuitry may update the CPT entry for that page to indicate the second page compression scheme and the new physical location of the recompressed data.

In some examples, the CPT may comprise entries for memory pages belonging to both the first compressed page class and the second compressed page class. The CPT may serve as a unified index for all compressed pages regardless of which compressed page class they belong to. Each entry in the CPT may include information that distinguishes pages compressed with the first page compression scheme from pages compressed with the second page compression scheme. The unified structure may simplify hardware implementation and lookup operations by providing a single table for locating any compressed page. The CPT entries may contain fields indicating the compression scheme used, allowing the decompression controller to apply the correct decompression algorithm when accessing the page. For example, the CPT may contain an entry for a page in the first compressed page class indicating it uses the first page compression scheme with low decompression latency, and another entry for a page in the second compressed page class indicating it uses the second page compression scheme with higher compression ratio, with both entries coexisting in the same CPT structure.

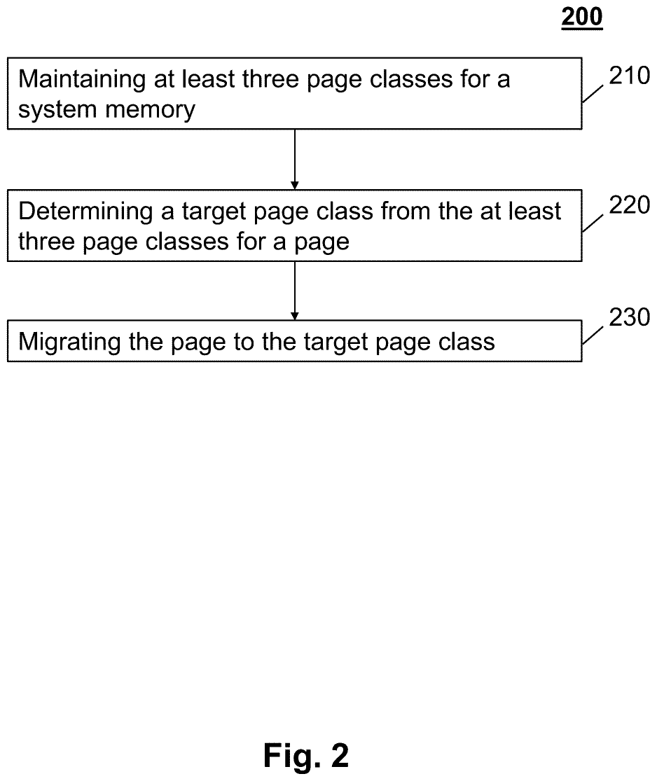

Further details and aspects are mentioned in connection with the examples described below. The example shown in FIG. 1 may include one or more optional additional features corresponding to one or more aspects mentioned in connection with the proposed concept or one or more examples described above below (e.g., FIGS. 2-5).

FIG. 2 illustrates a flowchart of an example of a method 200. The method 200 may, for instance, be performed by an apparatus as described herein, such as apparatus 100. The method 200 comprises maintaining 210 at least three page classes for a system memory. The at least three page classes comprises an uncompressed page class, a first compressed page class associated with a first page compression scheme, and a second compressed page class associated with a second page compression scheme. The method 200 further comprises determining 220 a target page class from the at least three page classes for a page based on the determined status indicator corresponding to a memory page, the status indicator comprising at least a write-recency indicator and a read-recency indicator. The method 200 further comprises, in response to a determination that the target page is not matching a current page class of the page, migrating 230 the page to the target page class.

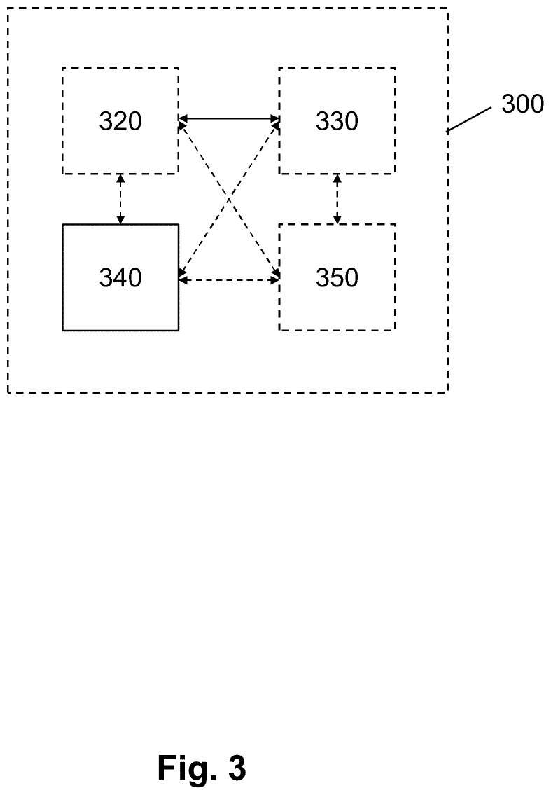

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-5).

FIG. 3 illustrates a block diagram of an example of a non-transitory computer-readable medium 340. The non-transitory computer-readable medium 340 stores instructions that, when executed by one or more processing circuitries 330, causes the one or more processing circuitries 330 to perform a method. The one or more processing circuitries 330 may access the non-transitory computer-readable medium 340 via an interface circuitry 320. In some examples, the non-transitory computer-readable medium 340, the one or more processing circuitries 330 and/or the interface circuitry 320 may be included in an apparatus 300. In some examples, the one or more processing circuitries 330 may be distributed over a plurality of apparatuses and may for example, access the non-transitory computer-readable medium 340 via the interface circuitry 320.

For example, the non-transitory computer-readable medium may refer to any tangible, physical medium capable of storing instructions, data, or other types of information for access by a computer, processor, or similar electronic device. The computer-readable medium may be non-transitory in that the medium may have a persistent or enduring form. The medium may retain stored information even when power is removed. The non-transitory computer-readable medium may comprise magnetic storage devices. Magnetic storage devices may include hard disk drives (HDDs) and magnetic tapes. Magnetic storage devices may store data using magnetic patterns. Magnetic storage devices may be used for long-term data storage in computers, servers, and backup systems. The non-transitory computer-readable medium may comprise optical storage media. Optical storage media may include compact discs (CDs), digital versatile discs (DVDs), and Blu-ray discs. Optical storage media may utilize laser technology to read and write data. Optical storage media may offer durability and longevity for storing software, media, and backups.

In some examples, the non-transitory computer-readable medium may comprise solid-state devices (SSDs). Solid-state devices may rely on flash memory technology. Solid-state devices may operate without moving parts. Solid-state devices may include USB flash drives, secure digital (SD) cards, or internal and external SSDs. Solid-state devices may provide fast read and write speeds and portability. In some examples, the non-transitory computer-readable medium may comprise non-volatile memory chips. Non-volatile memory chips may include read-only memory (ROM) and programmable ROM (PROM). Non-volatile memory chips may store firmware or embedded software. The non-volatile memory chips may be included in embedded systems and computers. In some examples, the non-transitory computer-readable medium may comprise phase-change memory (PCM). In some examples, the non-transitory computer-readable medium may comprise magnetoresistive RAM (MRAM). In some examples, the non-transitory computer-readable medium may comprise ferroelectric RAM (FeRAM). These memory technologies may offer persistent data storage with high reliability, speed, and power efficiency. These memory technologies may be suitable for applications requiring rapid access and data retention. Such applications may include mobile devices, high-performance computing, and industrial systems.

For example, the one or more processing circuitries 330 may access the non-transitory computer-readable medium 340 over the interface circuitry 320. For example, the one or more processing circuitries 330 may then execute the instructions stored on the non-transitory computer-readable medium 340. The execution of the instructions stored on the non-transitory computer-readable medium 340 causes the one or more processing circuitries 330 to the perform the method.

The method comprises maintaining at least three page classes for a system memory. The at least three page classes comprises an uncompressed page class, a first compressed page class associated with a first page compression scheme, and a second compressed page class associated with a second page compression scheme. The method further comprises determining a target page class from the at least three page classes for a page based on the determined status indicator corresponding to a memory page, the status indicator comprising at least a write-recency indicator and a read-recency indicator. The method further comprises, in response to a determination that the target page is not matching a current page class of the page, migrating the page to the target page class.

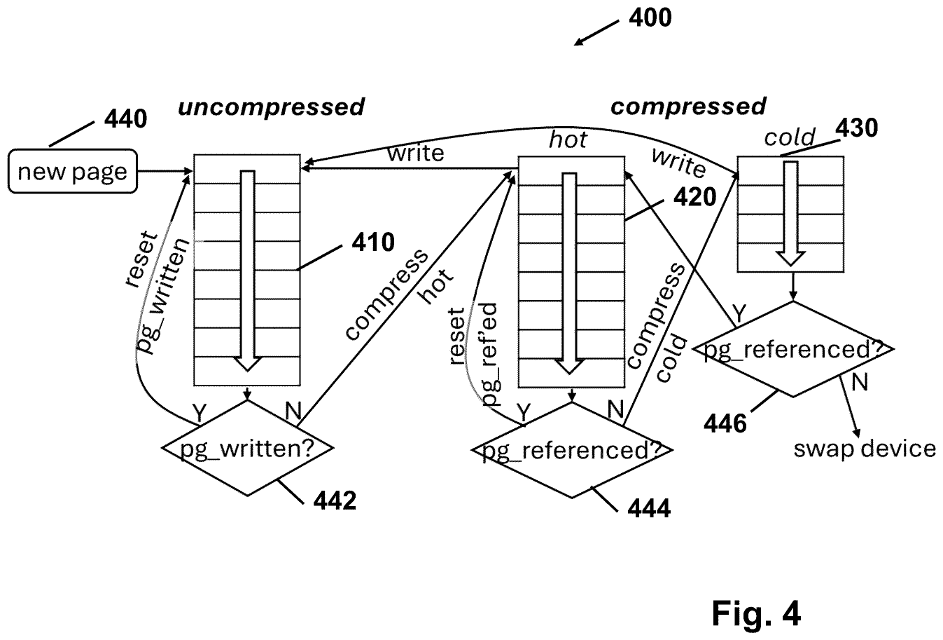

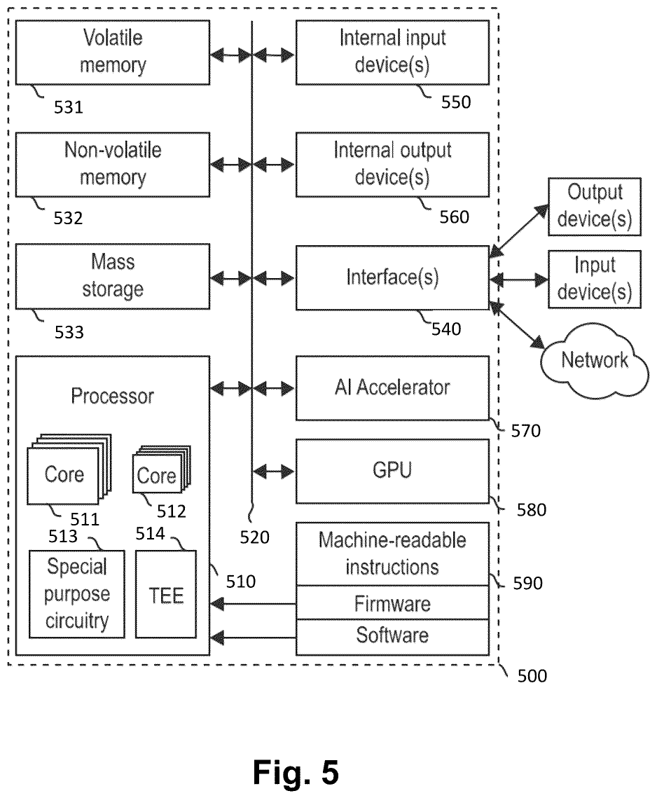

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-5).

### Further Examples

In some examples, memory compression may increase the usable memory capacity without requiring additional physical memory circuitry. Memory compression may also increase effective memory bandwidth by transferring compressed memory blocks through memory channels. However, memory compression may incur a performance penalty because data may need to be decompressed before it can be used by the processing circuitry. The main challenge in memory compression may be to compress as much data as possible while limiting the performance penalty.

In some examples, Transparent Memory Decompression (TMD) may enable low-latency decompression for reading compressed data, increasing the amount of data that can be compressed without a significant performance penalty. TMD may enable hardware-only decompression for reading compressed data without incurring a costly page fault. TMD may enable the compression of frequently accessed read-only data with a limited performance penalty. This may significantly increase the amount of data that can be compressed compared to approaches that only compress cold data due to high page fault overhead for decompression. In TMD, the machine-readable instructions (which may implement or comprise an operating system or OS memory manager) may be responsible for deciding which memory pages to compress. A page management policy may be needed to implement TMD. The machine-readable instructions may remain responsible for deciding which data to compress and to initiate compression of the data, while TMD may only decompress data on a read by the processing circuitry. The page management policy may reflect the primary goal of compressing as much data as possible while limiting performance overhead.

In some examples, memory compression may currently be done mostly for cold data, i.e., data that has not been accessed recently and likely will not be accessed in the near future. Cold data detection may be done by the machine-readable instructions (operating system) by checking how recently memory pages have been accessed. Transparent decompression (without incurring a page fault) may have lower overhead than OS-directed decompression and may have the potential to also compress highly accessed (hot) data. However, data that is often written should not be compressed because writes cannot be performed directly to compressed data. Writes to compressed data may generate a page fault to migrate the memory page to the uncompressed page class (or uncompressed partition), causing significant delays and performance loss. Cold data may be compressed at a higher degree because its low access frequency may allow for higher decompression latencies. Frequently accessed read-only data may be compressed, but may be compressed at a degree that enables fast decompression to limit decompression overhead. Infrequently accessed data (cold data) may be less sensitive to decompression latency and may be compressed at a higher degree, saving more memory capacity. The machine-readable instructions may differentiate between these access patterns (frequent-write, mostly-read, cold) to determine the optimal compression scheme (or page class).

FIG. 4 illustrates an example of a system 400 for managing memory pages. The system 400 comprises three LRU lists for managing memory pages according to their access patterns and compression states. The system 400 may implement a three-class page management policy for uncompressed often-written data, compressed mostly-read hot data, and compressed cold data. The three-class page management policy may be implemented by or comprise an operating system or OS memory manager (for example, the machine-readable instructions and the processing circuitry 130) to decide which memory pages to compress and to what degree. The goal of the policy may be to maximize the amount of compressed data (i.e., maximize capacity savings) while minimizing performance overhead. The policy may enable the implementation of TMD and may provide significant memory capacity savings with limited performance overhead. The system 400 comprises an uncompressed list 410, a compressed hot list 420, and a compressed cold list 430, each representing one of the at least three page classes (the uncompressed page class, the first compressed page class, and the second compressed page class, respectively).

The uncompressed list 410 (for example, implementing the uncompressed page class) maintains memory pages that are stored in uncompressed form. The uncompressed list 410 operates as a FIFO list where newly assigned pages and pages receiving write accesses are added at a tail of the list. Pages in the uncompressed list 410 progress toward a head of the list as they age. A new page 440 may be added to the tail of the uncompressed list 410, as indicated by the arrow from new page 440 to the uncompressed list 410. Pages at the head of the uncompressed list 410 may be periodically inspected, as indicated by decision diamond 442 “pg_written?”, to determine whether they should remain uncompressed or migrate to the compressed hot list 420. The inspection may occur during page scan phases or as part of memory management operations to keep each list at its predetermined size.

At decision diamond 442, the write-recency indicator (pg_written bit) of the memory page at the head of the uncompressed list 410 is evaluated. If the write-recency indicator indicates a recent write (Y branch from diamond 442), the memory page is moved back to the tail of the uncompressed list 410 with the write-recency indicator reset, as shown by the “reset pg_written” arrow looping back to the tail. If the write-recency indicator indicates an absence of recent writes (N branch from diamond 442), the memory page is compressed using the first page compression scheme (hot data scheme) and migrated to the compressed hot list 420, as indicated by the arrow labeled “compress hot” connecting the uncompressed list 410 to the compressed hot list 420.

The compressed hot list 420 (for example implementing the first compressed page class) maintains memory pages that are compressed using the first page compression scheme optimized for fast decompression. Pages in the compressed hot list 420 are organized as a FIFO list with pages progressing from tail to head. Pages at the head of the compressed hot list 420 are periodically inspected, as indicated by decision diamond 444 “pg_referenced?”, to determine whether they should remain in the first compressed page class or migrate to the second compressed page class. At decision diamond 444, the read-recency indicator (pg_referenced bit) of the memory page at the head of the compressed hot list 420 is evaluated. If the read-recency indicator indicates a recent read (Y branch from diamond 444), the memory page is moved back to the tail of the compressed hot list 420 with the read-recency indicator reset, as shown by the “reset pg_ref'ed” arrow looping back to the tail. If the read-recency indicator indicates an absence of recent reads (N branch from diamond 444), the memory page is recompressed using the second page compression scheme and migrated to the compressed cold list 430, as indicated by the arrow labeled “compress cold” connecting the compressed hot list 420 to the compressed cold list 430.

The compressed cold list 430 (implementing the second compressed page class) maintains memory pages that are compressed using the second page compression scheme optimized for high compression ratio. Pages in the compressed cold list 430 are organized as a FIFO list with pages progressing from tail to head. Pages at the head of the compressed cold list 430 are periodically inspected, as indicated by decision diamond 446 labeled “pg_referenced?”, to determine whether they should remain in system memory or be swapped to a persistent storage medium. At decision diamond 446, the read-recency indicator (pg_referenced bit) of the memory page at the head of the compressed cold list 430 is evaluated. If the read-recency indicator indicates an absence of recent reads (N branch from diamond 446), the memory page is swapped to a swap device (for example, to a persistent storage medium), as shown by the arrow pointing to “swap device”. If the read-recency indicator indicates a recent read (Y branch from diamond 446), the memory page may be migrated to the compressed hot list 42

The system 400 further illustrates migration paths for write accesses to compressed pages. When a write access targets a memory page in the compressed hot list 420, the write access generates a page fault that triggers migration of the memory page directly to the uncompressed list 410, as indicated by the arrow labeled “write” connecting the compressed hot list 420 to the tail of the uncompressed list 410. Similarly, when a write access targets a memory page in the compressed cold list 430, the write access generates a page fault that triggers migration of the memory page directly to the uncompressed list 410, as indicated by the arrow labeled “write” connecting the compressed cold list 430 to the tail of the uncompressed list 410. These write-triggered migrations follow the TMD scheme, where writes to compressed pages automatically cause decompression and the memory page is moved to the tail of the uncompressed list 410 in a write-decompress handler.

The system 400 may implement a comprehensive page management policy where pages migrate between the three lists based on their access patterns. The uncompressed list 410 keeps recently written pages uncompressed, but recently read pages may eventually move to the compressed hot list 420. Pages that migrate from the uncompressed list 410 to the compressed hot list 420 are initially compressed at a low degree using the first page compression scheme, allowing for fast read access. The read-recency indicator (pg_referenced bit) may be kept as it was in the uncompressed list 410, either set if the memory page was recently read or unset if it was not recently read. The write-recency indicator (pg_written bit) may not be used in the compressed partition but may normally not be set when a page migrates to the compressed hot list 420.

The compressed hot list 420 may operate using the read-recency indicator (pg_referenced bit). Pages that are not recently referenced are migrated to the compressed cold list 430 and recompressed to a higher degree using the second page compression scheme because they are unlikely to be accessed again soon. Writes to compressed pages are detected by the TMD system and cause a page fault, migrating the pages to the uncompressed list 410 and removing them from the compressed lists. In case the compressed partition is filling up, pages from the compressed cold list 430 may be swapped to the persistent storage medium (swap device). Migrations of pages are initiated during page faults (adding new page or moving compressed page to uncompressed on a write page fault) and periodically during page scan phases. The LRU lists are only updated during these events.

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIG. 5).

FIG. 5 illustrates a block diagram of an example computer system 500 or computing device 500 structured to execute and/or instantiate the machine-readable instructions and/or operations of FIGS. 1 to 4 in order to implement the apparatus/device 100 or 200, or method 300 or system 400 as described. The computer system 500 or computing device 500 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 500 or computing device 500 of the illustrated example includes processor circuitry 510. The processor circuitry 510 of the illustrated example is hardware. For example, the processor circuitry 510 can be implemented by one or more integrated circuits, logic circuits, FPGAs (Field-Programmable Gate Array), microprocessors, CPUs (Central Processing Units), GPUs (Graphics Processing Units), DSPs (Digital Signal Processors), and/or microcontrollers from any desired family or manufacturer. The processor circuitry 510 may be implemented by one or more semiconductor-based (e.g., silicon-based) devices. For example, the processor circuitry 510 may provide the functionality of the computer system 500 or computing device 500. Accordingly, the computing system being used to implement the proposed concept may be a CPU-based computing system, a GPU based computing system, an AI Accelerator computing system, or any other computing system that uses volatile memory. The computing system that implements this solution may be a sub-part of a larger computing system. For example, the computer system 100 of FIG. 1a may be one of a CPU-based computing system, a GPU based computing system, an AI Accelerator computing system, or any other computing system that uses volatile memory.

The processor circuitry 510 comprises one or more processor cores 511, 512. For example, the processor circuitry 510 may have heterogeneous cores. Heterogeneous cores in CPUs refer to the use of different types of cores within a single processor, typically combining high-performance (BIG) cores with power-efficient (LITTLE) cores. Thus, the processor circuitry 510 may comprise one or more BIG cores 511 and one or more LITTLE cores 512. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 510 of the illustrated example is in communication with, e.g., via one or more bus interfaces 520, the main memory including a volatile memory 531 and a non-volatile memory 532. The volatile memory 531 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 532 may be implemented by flash memory and/or any other desired type of memory device. Access to the main memory 531, 532 of the illustrated example is controlled by a memory controller, which may be implemented by special-purpose circuitry 513 of the processor circuitry 510.

The computer system 500 or computing device 500 of the illustrated example also includes one or more mass storage devices 533 to store software and/or data. Examples of such mass storage devices 533 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 500 or computing device 500 of the illustrated example also includes interface circuitry 540. The interface circuitry 540 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect Express) interface. For example, the interface circuitry 540 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-sight wireless system, a cellular telephone system, an optical connection, etc.

In the illustrated example, one or more internal input devices 550 and/or one or more external input devices are connected to the interface circuitry 540 or the bus 520. The input device(s) permit a user to enter data and/or commands into the processor circuitry 510. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 560 and/or one or more external output devices are also connected to the interface circuitry 540 of the illustrated example. The output devices 560 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The computer system 500 or computing device 500 of the illustrated example, thus, typically includes a graphics driver card, a graphics driver chip, and/or graphics processor circuitry such as a GPU 513, 580, which may correspond to or be part of the processor circuitry 510, for example as special purpose circuitry 513, or as cores 511, 512, or separate from the processor 510, for example as a separate GPU 580.

The computer system 500 or computing device 500 of the illustrated example may include an AI Accelerator 570. For example, the AI Accelerator 570 may be configured to improve the computational speed and efficiency of machine learning tasks by executing parallel processing operations tailored for neural network models. The AI Accelerator 570 may include hardware such as Graphics Processing Units (GPUs), Tensor Processing Units (TPUs), or other specialized processors designed to handle large volumes of data with low latency. For example, the Processor 510, the AI Accelerator 570, the integrated GPU 513, and/or the dedicated GPU 580 may be considered xPUs (x Processing Units, where x is a placeholder) of the computer system 700 or computing device 700.

The computer system 500 or computing device 500 of the illustrated example includes machine-readable instructions 590. For example, the machine-readable instructions may be part of firmware or software of the computer system 500 or computing device 500. The machine-readable instructions 590 may be stored in the mass storage device 533, in the volatile memory 531, in the non-volatile memory 532, and/or on a removable non-transitory computer-readable storage medium such as a CD or DVD.

Further details and aspects are mentioned in connection with the examples described above. The example shown in FIG. 5 may include one or more optional additional features corresponding to one or more aspects mentioned in connection with the proposed concept or one or more examples described above (e.g., FIGS. 1-4).

In the following, some examples of the proposed concept are presented:

An example (e.g., example 1) relates to an apparatus comprising processing circuitry and machine-readable instructions, wherein the processing circuitry is to execute the machine-readable instructions to maintain at least three page classes for a system memory, the at least three page classes comprising an uncompressed page class, a first compressed page class associated with a first page compression scheme, and a second compressed page class associated with a second page compression scheme, determine a target page class from the at least three page classes for a page based on the determined status indicator corresponding to a memory page, the status indicator comprising at least a write-recency indicator and a read-recency indicator, and in response to a determination that the target page is not matching a current page class of the page migrate the page to the target page class.

Another example (e.g., example 2) relates to a previous example (e.g., example 1) or to any other example, further comprising that determining the target page class comprises determining the uncompressed page class as the target page class in response to the write-recency indicator indicating a recent write.

Another example (e.g., example 3) relates to a previous example (e.g., one of the examples 1 to 2) or to any other example, further comprising that determining the target page class comprises determining the first compressed page class as the target page class in response to the write-recency indicator indicating an absence of recent writes for a page currently in the uncompressed page class.

Another example (e.g., example 4) relates to a previous example (e.g., one of the examples 1 to 3) or to any other example, further comprising that migrating the memory page from the uncompressed class to the first compressed class comprises compressing the memory page using the first compression scheme.

Another example (e.g., example 5) relates to a previous example (e.g., one of the examples 1 to 4) or to any other example, further comprising that determining the target page class comprises determining the second compressed page class as the target page class in response to the read-recency indicator indicating an absence of recent reads for a page currently in the first compressed page class.

Another example (e.g., example 6) relates to a previous example (e.g., one of the examples 1 to 5) or to any other example, further comprising that migrating the memory page from the first compressed class to the second compressed class comprises recompressing the memory page using the second compression scheme.

Another example (e.g., example 7) relates to a previous example (e.g., one of the examples 1 to 6) or to any other example, further comprising that the processing circuitry is further to execute the machine-readable instructions to, in response to the read-recency indicator indicating an absence of recent reads for a page currently in the second compressed page class, swap the memory page to a persistent storage medium.

Another example (e.g., example 8) relates to a previous example (e.g., one of the examples 1 to 7) or to any other example, further comprising that the processing circuitry is further to execute the machine-readable instructions to, in response to a write access targeting the memory page while it is in a compressed page class, migrate the memory page directly to the uncompressed page class.

Another example (e.g., example 9) relates to a previous example (e.g., example 8) or to any other example, further comprising that migrating the memory page to the uncompressed class comprises decompressing the memory page.

Another example (e.g., example 10) relates to a previous example (e.g., one of the examples 1 to 9) or to any other example, further comprising that migrating the page to the target page class comprises compressing or recompressing the memory page.

Another example (e.g., example 11) relates to a previous example (e.g., one of the examples 1 to 10) or to any other example, further comprising that a read access to the memory page being in the compressed page class is serviced by a decompression controller transparently to an operating system, without generating an operating system page fault.

Another example (e.g., example 12) relates to a previous example (e.g., one of the examples 1 to 11) or to any other example, further comprising a decompression controller being configured to perform decompression transparently to an operating system without generating an operating system page fault when the memory page receives a read access in the compressed page class.

Another example (e.g., example 13) relates to a previous example (e.g., one of the examples 1 to 12) or to any other example, further comprising that the processing circuitry is further to execute the machine-readable instructions to initiate the determining of the target page class for the memory page in response to at least one of an insertion of the memory page into system memory, the memory page reaching a head of a list corresponding to its current class during a page scan phase or a page fault associated with the memory page.

Another example (e.g., example 14) relates to a previous example (e.g., one of the examples 1 to 13) or to any other example, further comprising that the first page compression scheme has a lower decompression latency than the second page compression scheme.

Another example (e.g., example 15) relates to a previous example (e.g., one of the examples 1 to 14) or to any other example, further comprising that each of the at least three page classes is implemented as a respective list.

Another example (e.g., example 16) relates to a previous example (e.g., example 15) or to any other example, further comprising that determining of the target page class for the memory page is initiated in response to the memory page reaching a predetermined position within the respective list corresponding to its current page class.

Another example (e.g., example 17) relates to a previous example (e.g., one of the examples 1 to 16) or to any other example, further comprising that a compressed page table comprises entries for memory pages belonging to both the first compressed page class and the second compressed page class.

Another example (e.g., example 18) relates to a previous example (e.g., one of the examples 1 to 17) or to any other example, further comprising that migrating the page to the target page class comprises updating a compressed page table, the compressed page table comprising entries for memory pages belonging to both the first compressed page class and the second compressed page class.

Another example (e.g., example 19) relates to a previous example (e.g., one of the examples 1 to 18) or to any other example, further comprising that the write-recency indicator is distinct from a writeback indicator used to track a writeback requirement for the memory page.

An example (e.g., example 20) relates to a method comprising maintaining at least three page classes for a system memory, the at least three page classes comprising an uncompressed page class, a first compressed page class associated with a first page compression scheme, and a second compressed page class associated with a second page compression scheme, determining a target page class from the at least three page classes for a page based on a determined status indicator corresponding to a memory page, the status indicator comprising at least a write-recency indicator and a read-recency indicator, and in response to a determination that the target page is not matching a current page class of the page, migrating the page to the target page class.

Another example (e.g., example 21) relates to a previous example (e.g., example 20) or to any other example, further comprising that determining the target page class comprises determining the uncompressed page class as the target page class in response to the write-recency indicator indicating a recent write.

Another example (e.g., example 22) relates to a previous example (e.g., one of the examples 20 to 21) or to any other example, further comprising that determining the target page class comprises determining the first compressed page class as the target page class in response to the write-recency indicator indicating an absence of recent writes for a page currently in the uncompressed page class.

Another example (e.g., example 23) relates to a previous example (e.g., one of the examples 20 to 22) or to any other example, further comprising that migrating the memory page from the uncompressed class to the first compressed class comprises compressing the memory page using the first compression scheme.

Another example (e.g., example 24) relates to a previous example (e.g., one of the examples 20 to 23) or to any other example, further comprising that determining the target page class comprises determining the second compressed page class as the target page class in response to the read-recency indicator indicating an absence of recent reads for a page currently in the first compressed page class.

Another example (e.g., example 25) relates to a previous example (e.g., one of the examples 20 to 24) or to any other example, further comprising that migrating the memory page from the first compressed class to the second compressed class comprises recompressing the memory page using the second compression scheme.

Another example (e.g., example 26) relates to a previous example (e.g., one of the examples 20 to 25) or to any other example, further comprising in response to the read-recency indicator indicating an absence of recent reads for a page currently in the second compressed page class, swapping the memory page to a persistent storage medium.

Another example (e.g., example 27) relates to a previous example (e.g., one of the examples 20 to 26) or to any other example, further comprising in response to a write access targeting the memory page while it is in a compressed page class, migrating the memory page directly to the uncompressed page class.

Another example (e.g., example 28) relates to a previous example (e.g., example 27) or to any other example, further comprising that migrating the memory page to the uncompressed class comprises decompressing the memory page.

Another example (e.g., example 29) relates to a previous example (e.g., one of the examples 20 to 28) or to any other example, further comprising that migrating the page to the target page class comprises compressing or recompressing the memory page.

Another example (e.g., example 30) relates to a previous example (e.g., one of the examples 20 to 29) or to any other example, further comprising that a read access to the memory page being in the compressed page class is serviced by a decompression controller transparently to an operating system, without generating an operating system page fault.

Another example (e.g., example 31) relates to a previous example (e.g., one of the examples 20 to 30) or to any other example, further comprising that decompression is performed by a decompression controller transparently to an operating system without generating an operating system page fault when the memory page receives a read access in the compressed page class.

Another example (e.g., example 32) relates to a previous example (e.g., one of the examples 20 to 31) or to any other example, further comprising initiating the determining of the target page class for the memory page in response to at least one of an insertion of the memory page into system memory, the memory page reaching a head of a list corresponding to its current class during a page scan phase, or a page fault associated with the memory page.

Another example (e.g., example 33) relates to a previous example (e.g., one of the examples 20 to 32) or to any other example, further comprising that the first page compression scheme has a lower decompression latency than the second page compression scheme.

Another example (e.g., example 34) relates to a previous example (e.g., one of the examples 20 to 33) or to any other example, further comprising that each of the at least three page classes is implemented as a respective list.

Another example (e.g., example 35) relates to a previous example (e.g., example 34) or to any other example, further comprising that determining of the target page class for the memory page is initiated in response to the memory page reaching a predetermined position within the respective list corresponding to its current page class.

Another example (e.g., example 36) relates to a previous example (e.g., one of the examples 20 to 35) or to any other example, further comprising that a compressed page table comprises entries for memory pages belonging to both the first compressed page class and the second compressed page class.

Another example (e.g., example 37) relates to a previous example (e.g., one of the examples 20 to 36) or to any other example, further comprising that migrating the page to the target page class comprises updating a compressed page table, the compressed page table comprising entries for memory pages belonging to both the first compressed page class and the second compressed page class.

Another example (e.g., example 38) relates to a previous example (e.g., one of the examples 20 to 37) or to any other example, further comprising that the write-recency indicator is distinct from a writeback indicator used to track a writeback requirement for the memory page.

An example (e.g., example 39) relates to a non-transitory computer-readable medium storing instructions that, when executed by one or more processing circuitries, causing the one or more processing circuitries to perform a method comprising maintaining at least three page classes for a system memory, the at least three page classes comprising an uncompressed page class, a first compressed page class associated with a first page compression scheme, and a second compressed page class associated with a second page compression scheme, determining a target page class from the at least three page classes for a page based on a determined status indicator corresponding to a memory page, the status indicator comprising at least a write-recency indicator and a read-recency indicator, and in response to a determination that the target page is not matching a current page class of the page, migrating the page to the target page class.

Another example (e.g., example 40) relates to a previous example (e.g., example 39) or to any other example, further comprising that determining the target page class comprises determining the uncompressed page class as the target page class in response to the write-recency indicator indicating a recent write.

Another example (e.g., example 41) relates to a previous example (e.g., one of the examples 39 to 40) or to any other example, further comprising that determining the target page class comprises determining the first compressed page class as the target page class in response to the write-recency indicator indicating an absence of recent writes for a page currently in the uncompressed page class.

Another example (e.g., example 42) relates to a previous example (e.g., one of the examples 39 to 41) or to any other example, further comprising that migrating the memory page from the uncompressed class to the first compressed class comprises compressing the memory page using the first compression scheme.

Another example (e.g., example 43) relates to a previous example (e.g., one of the examples 39 to 42) or to any other example, further comprising that determining the target page class comprises determining the second compressed page class as the target page class in response to the read-recency indicator indicating an absence of recent reads for a page currently in the first compressed page class.

Another example (e.g., example 44) relates to a previous example (e.g., one of the examples 39 to 43) or to any other example, further comprising that migrating the memory page from the first compressed class to the second compressed class comprises recompressing the memory page using the second compression scheme. 45. The non-transitory computer-readable medium of any one of examples 39 to 44, wherein the method further comprises, in response to the read-recency indicator indicating an absence of recent reads for a page currently in the second compressed page class, swapping the memory page to a persistent storage medium.

Another example (e.g., example 46) relates to a previous example (e.g., one of the examples 39 to 45) or to any other example, further comprising that the method further comprises, in response to a write access targeting the memory page while it is in a compressed page class, migrating the memory page directly to the uncompressed page class.

Another example (e.g., example 47) relates to a previous example (e.g., example 46) or to any other example, further comprising that migrating the memory page to the uncompressed class comprises decompressing the memory page.

Another example (e.g., example 48) relates to a previous example (e.g., one of the examples 39 to 47) or to any other example, further comprising that migrating the page to the target page class comprises compressing or recompressing the memory page.

Another example (e.g., example 49) relates to a previous example (e.g., one of the examples 39 to 48) or to any other example, further comprising that a read access to the memory page being in the compressed page class is serviced by a decompression controller transparently to an operating system, without generating an operating system page fault.

Another example (e.g., example 50) relates to a previous example (e.g., one of the examples 39 to 49) or to any other example, further comprising that decompression is performed by a decompression controller transparently to an operating system without generating an operating system page fault when the memory page receives a read access in the compressed page class.

Another example (e.g., example 51) relates to a previous example (e.g., one of the examples 39 to 50) or to any other example, further comprising that the method further comprises initiating the determining of the target page class for the memory page in response to at least one of an insertion of the memory page into system memory, the memory page reaching a head of a list corresponding to its current class during a page scan phase, or a page fault associated with the memory page.

Another example (e.g., example 52) relates to a previous example (e.g., one of the examples 39 to 51) or to any other example, further comprising that the first page compression scheme has a lower decompression latency than the second page compression scheme.

Another example (e.g., example 53) relates to a previous example (e.g., one of the examples 39 to 52) or to any other example, further comprising that each of the at least three page classes is implemented as a respective list.

Another example (e.g., example 54) relates to a previous example (e.g., example 53) or to any other example, further comprising that determining of the target page class for the memory page is initiated in response to the memory page reaching a predetermined position within the respective list corresponding to its current page class.

Another example (e.g., example 55) relates to a previous example (e.g., one of the examples 39 to 54) or to any other example, further comprising that a compressed page table comprises entries for memory pages belonging to both the first compressed page class and the second compressed page class.

Another example (e.g., example 56) relates to a previous example (e.g., one of the examples 39 to 55) or to any other example, further comprising that migrating the page to the target page class comprises updating a compressed page table, the compressed page table comprising entries for memory pages belonging to both the first compressed page class and the second compressed page class.

Another example (e.g., example 57) relates to a previous example (e.g., one of the examples 39 to 56) or to any other example, further comprising that the write-recency indicator is distinct from a writeback indicator used to track a writeback requirement for the memory page.

An example (e.g., example 58) relates to an apparatus comprising a processor circuitry configured to maintain at least three page classes for a system memory, the at least three page classes comprising an uncompressed page class, a first compressed page class associated with a first page compression scheme, and a second compressed page class associated with a second page compression scheme, determine a target page class from the at least three page classes for a page based on a determined status indicator corresponding to a memory page, the status indicator comprising at least a write-recency indicator and a read-recency indicator, and in response to a determination that the target page is not matching a current page class of the page, migrate the page to the target page class.

An example (e.g., example 59) relates to a device comprising means for processing for maintaining at least three page classes for a system memory, the at least three page classes comprising an uncompressed page class, a first compressed page class associated with a first page compression scheme, and a second compressed page class associated with a second page compression scheme, determining a target page class from the at least three page classes for a page based on a determined status indicator corresponding to a memory page, the status indicator comprising at least a write-recency indicator and a read-recency indicator, and in response to a determination that the target page is not matching a current page class of the page, migrating the page to the target page class.

Another example (e.g., example 60) relates to a computer program having a program code for performing the method of any one of examples 20 to 38 when the computer program is executed on a computer, a processor, or a programmable hardware component.

Another example (e.g., example 61) relates machine-readable storage including machine readable instructions, when executed, to implement a method or realize an apparatus as claimed in any pending claim.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising processing circuitry and machine-readable instructions, wherein the processing circuitry is to execute the machine-readable instructions to:
maintain at least three page classes for a system memory, the at least three page classes comprising an uncompressed page class, a first compressed page class associated with a first page compression scheme, and a second compressed page class associated with a second page compression scheme;
determine a target page class from the at least three page classes for a page based on the determined status indicator corresponding to a memory page, the status indicator comprising at least a write-recency indicator and a read-recency indicator; and
in response to a determination that the target page is not matching a current page class of the page migrate the page to the target page class.

2. The apparatus of claim 1, wherein determining the target page class comprises determining the uncompressed page class as the target page class in response to the write-recency indicator indicating a recent write.

3. The apparatus of claim 1, wherein determining the target page class comprises determining the first compressed page class as the target page class in response to the write-recency indicator indicating an absence of recent writes for a page currently in the uncompressed page class.

4. The apparatus of claim 1, wherein migrating the memory page from the uncompressed class to the first compressed class comprises compressing the memory page using the first compression scheme.

5. The apparatus of claim 1, wherein determining the target page class comprises determining the second compressed page class as the target page class in response to the read-recency indicator indicating an absence of recent reads for a page currently in the first compressed page class.

6. The apparatus of claim 1, wherein migrating the memory page from the first compressed class to the second compressed class comprises recompressing the memory page using the second compression scheme.

7. The apparatus of claim 1, wherein the processing circuitry is further to execute the machine-readable instructions to, in response to the read-recency indicator indicating an absence of recent reads for a page currently in the second compressed page class, swap the memory page to a persistent storage medium.

8. The apparatus of claim 1, wherein the processing circuitry is further to execute the machine-readable instructions to, in response to a write access targeting the memory page while it is in a compressed page class, migrate the memory page directly to the uncompressed page class.

9. The apparatus of claim 8, wherein migrating the memory page to the uncompressed class comprises decompressing the memory page.

10. The apparatus of claim 1, wherein migrating the page to the target page class comprises compressing or recompressing the memory page.

11. The apparatus of claim 1, wherein a read access to the memory page being in the compressed page class is serviced by a decompression controller transparently to an operating system, without generating an operating system page fault.

12. The apparatus of claim 1, further comprising a decompression controller being configured to perform decompression transparently to an operating system without generating an operating system page fault when the memory page receives a read access in the compressed page class.

13. The apparatus of claim 1, wherein the processing circuitry is further to execute the machine-readable instructions to initiate the determining of the target page class for the memory page in response to at least one of: an insertion of the memory page into system memory, the memory page reaching a head of a list corresponding to its current class during a page scan phase or a page fault associated with the memory page.

14. The apparatus of claim 1, wherein the first page compression scheme has a lower decompression latency than the second page compression scheme.

15. The apparatus of claim 1, wherein each of the at least three page classes is implemented as a respective list.

16. The apparatus of claim 15, wherein determining of the target page class for the memory page is initiated in response to the memory page reaching a predetermined position within the respective list corresponding to its current page class.

17. The apparatus of claim 1, wherein a compressed page table comprises entries for memory pages belonging to both the first compressed page class and the second compressed page class.

18. The apparatus of claim 1, wherein migrating the page to the target page class comprises updating a compressed page table, the compressed page table comprising entries for memory pages belonging to both the first compressed page class and the second compressed page class.

19. A non-transitory computer-readable medium storing instructions that, when executed by one or more processing circuitries, causing the one or more processing circuitries to perform a method comprising:
maintaining at least three page classes for a system memory, the at least three page classes comprising an uncompressed page class, a first compressed page class associated with a first page compression scheme, and a second compressed page class associated with a second page compression scheme;
determining a target page class from the at least three page classes for a page based on the determined status indicator corresponding to a memory page, the status indicator comprising at least a write-recency indicator and a read-recency indicator; and
in response to a determination that the target page is not matching a current page class of the page migrating the page to the target page class.

20. A method comprising:
maintaining at least three page classes for a system memory, the at least three page classes comprising an uncompressed page class, a first compressed page class associated with a first page compression scheme, and a second compressed page class associated with a second page compression scheme;
determining a target page class from the at least three page classes for a page based on the determined status indicator corresponding to a memory page, the status indicator comprising at least a write-recency indicator and a read-recency indicator; and
in response to a determination that the target page is not matching a current page class of the page migrating the page to the target page class.
